(19) United States
(12) Patent Application Publication
(10) Pub. No.: US 2014/0265761 A1
(43) Pub. Date: Sep. 18, 2014

(54) LOCKING DEVICE

(71) Applicant: FULTERER GESELLSCHAFT MBH, Lustenau (AT)

(72) Inventor: Markus Ropele, Lauterach (AT)

(73) Assignee: FULTERER GESELLSCHAFT MBH, Lustenau (AT)

(21) Appl. No.: 14/202,475

(22) Filed: Mar. 10, 2014

(30) Foreign Application Priority Data
Mar. 14, 2013 (AT) A204/2013

(51) Int. Cl. E05B 65/46

(52) U.S. Cl. CPC E05B 65/464
USPC 312/218

(57) ABSTRACT

A locking device (1) for a pull-out blocking arrangement (2) for at least two furniture parts, in particular drawers, which can be pushed into a furniture body and pulled out of a furniture body, wherein the locking device (1) comprises a locking body (4) which is pivotable about a pivot axis (3) and is pivotable between at least one blocking position for blocking the furniture parts in their pushed-in position and at least one release position for pulling at least one of the furniture parts out of the furniture body, wherein the locking body (4) is pivotable about the pivot axis (3) out of the blocking position into the release position in two pivot directions (5, 6) which are opposite one another.

### BACKGROUND

The present invention relates to a locking device for a pull-out blocking arrangement for at least two furniture parts, in particular drawers, which can be pushed into a furniture body and pulled out of a furniture body, wherein the locking device comprises a locking body which is pivotable about a pivot axis and is pivotable between at least one blocking position for blocking the furniture parts in their pushed-in position and at least one release position for pulling at least one of the furniture parts out of the furniture body.

A plurality of configurations of pull-out blocking arrangements are known in the prior art. They serve for the purpose of preventing additional extractable furniture parts such as, for example, drawers, being able to be pulled out of a furniture body when other correspondingly extractable furniture parts or drawers have already been pulled out of said furniture body. In the majority of cases this is to prevent the furniture body from inadvertently becoming unbalanced or falling over when too many extractable furniture parts or drawers are pulled out of it at the same time. Such pull-out blocking arrangements then usually block the pulling-out of further extractable furniture parts or drawers whenever just one single retractable furniture part has already been pulled out of the furniture body. Such a pull-out blocking arrangement is shown, for example, in EP 2 497 883 A2. In order to create a lockable pull-out blocking arrangement, this document provides a generic locking device which is designated in said document as a lock. If the locking body of said locking device, which is pivotable about the pivot axis, is situated in its blocking position, none of the retractable furniture parts can be pulled out of the furniture body. In the release position of the locking body, at least one retractable furniture part or one such drawer can be pulled out of the furniture body, as a result of which the other furniture parts are then blocked again and cannot be pulled out of the furniture body.

Other pull-out blocking arrangements are shown, for example, in DE 195 47 049 A1 or EP 2 128 364 A1.

### SUMMARY

It is the object of the invention to improve a locking device of the above-mentioned type to the effect that it can be used in as flexible a manner as possible.

To this end, it is provided according to the invention that the locking body is pivotable about the pivot axis out of the blocking position into the release position in two pivot directions which are opposite one another.

In contrast to the named prior art where the locking body can only be pivoted out of the blocking position into the release position in one single pivot direction, greater flexibility is created in the application possibilities for locking devices according to the invention as a result of the two pivot directions, which are now provided according to the invention and are opposite one another, in which the locking body is able to be pivoted out of the blocking position. The locking devices according to the invention can now be actuated by the most varied locks, be it then locks with keys or electronic locks or other types of locks. As a result of the locking devices according to the invention having two pivot directions which are opposite to one another, it is no longer a question of the direction in which the type of lock used in combination with the locking device opens and/or closes. Locking devices according to the invention can be combined both with locks that open in a clockwise manner and with locks that open in an anticlockwise manner.

When the locking device according to the invention comprises several blocking positions and/or several release positions, it is provided correspondingly according to the invention that the locking body is pivotable about the pivot axis out of the blocking position or at least out of one of the blocking positions into the release position or at least into one of the release positions in two pivot directions which are opposite one another.

It is favorable when the locking device comprises a connecting piece for connection to a lock. This connection piece should then be in direct or at least indirect operative connection to the locking body. In this case it is favorable when a positive coupling, which ensures that the locking body is rotated when the connecting piece is rotated, is provided between the connecting piece and the locking body. In particularly preferred variants, the connecting piece is realized integrally with the locking body.

It is also favorable in this context when the locking body is pivotable about the pivot axis out of the release position or at least out of one of the release positions, preferably out of all of the release positions into the blocking position or at least into one of the blocking positions, preferably into all of the blocking positions in two pivot directions which are opposite one another. It is preferred that the locking body is pivotable about the pivot axis both clockwise and also counter-clockwise.

In terms of flexibly usability of the locking device according to the invention, particularly preferred configurations provide that the locking body is pivotable about the pivot axis about more than 360°, preferably endlessly, in at least one of the pivot directions, preferably in the two pivot directions which are opposite one another. In order to secure defined end positions, it can be provided that the locking body is mounted in a supporting body so as to be pivotable about the pivot axis and the locking body and/or the supporting body comprises or comprise at least one latching element for releasably latching in at least one blocking position and/or in at least one release position. In this case, the latching element can be arranged both on the supporting body and on the locking body. It is also possible that both the supporting body and the locking body comprise interacting latching elements. It is also possible for more than one latching element to be provided, for example in order to ensure latching in a predefined release position and in a predefined blocking position. Flexible lugs and regions which interact together in a frictional manner or the like can be used as latching elements.

In order to be able to fasten the locking device in the pull-out blocking arrangement, in particular on the rails thereof, preferred configurations of the invention provide that the locking device comprises a fastening device for fastening the locking device on a rail of a pull-out blocking arrangement. The fastening devices can be, for example, screws, rivets, clamping connections or even just holes for fastening screws.

In order to support the locking body as well as possible so that it is sufficiently sturdy even in the case of larger forces acting on it, for example as a result of faulty operation, particularly preferred configurations of the invention provide that the locking body is mounted so as to be pivotable about the pivot axis in a supporting body on at least two bearing points which are spaced apart from one another in the longitudinal direction of the pivot axis. The locking body does not forcibly have to be supported between the bearing points in this case. It can be provided in this sense that the locking body is free of a supporting arrangement between the bearing points which are spaced apart from one another.

Preferred configurations of the invention provide that the locking body comprises at least two locking arms which are spaced apart from one another in the longitudinal direction of the pivot axis and extend out from the pivot axis in the radial direction. In this case, it is provided in a preferred manner that said locking body interacts in the blocking position with a stop piece of the pull-out blocking arrangement by way of a locking arm or, provided in these exemplary embodiments, the two locking arms. Particularly preferred configurations of the invention provide in the case of variants with at least two locking arms that the supporting body comprises a spring body receiving means for supporting a spring body and, when the locking body is pivoted about the pivot axis, the locking arms on opposite sides of the spring body receiving means can be pivoted past said spring body receiving means.

In terms of particularly strong sturdiness of the locking device or of the locking body, in particular also in the event of faulty operations, it can be provided that the locking body, preferably a locking arm or the locking arms, comprises at least one abutment face which is arranged inclined with respect to the radial direction, with reference to the pivot axis, for abutting against a counter abutment face of the pull-out blocking arrangement. This can prevent the locking arm or the locking arms from being pushed away to the side. In preferred configurations even relatively small angles are sufficient to do this. Thus, for example, it can be provided that the abutment face which is arranged inclined with respect to the radial direction comprises an angle between 3° and 10° in relation to a plane standing normally along the radial direction, preferably an angle of between 4° and 7° in relation to a plane standing normally along the radial direction.

Apart from the locking device itself, the invention also relates to a pull-out blocking arrangement which comprises at least one locking device according to the invention for blocking the furniture parts in their pushed-in position. If the locking device or its locking body is situated in the release position, at least one, preferably precisely one, furniture part can be pulled out of the furniture part. In a favorable manner, the pull-out blocking arrangement comprise a stop piece with which the locking body preferably the locking arm thereof or the locking arms thereof interact in the blocking position. This stop piece can comprise a corresponding number of counter support faces for the abutment face or the abutment faces of the locking body or of the locking arms. This counter abutment faces can also be realized in a correspondingly inclined manner with respect to the named radial direction in order to be able to interact in an optimum manner with the abutment faces of the locking body or of the locking arm or of the locking arms.

### BRIEF DESCRIPTION OF THE SEVERAL VIEWS OF THE DRAWINGS

Further features and details of preferred configurations of the invention are explained below by way of the description of the Figures, in which:

FIGS. 1 and 2 show a generic locking device according to the prior art;

FIGS. 3 to 6 show different views and positions of locking devices according to the invention;

FIG. 7 shows an exploded drawing of the locking device according to the invention according to FIGS. 3 to 6;

FIGS. 8 and 9 show a pull-out blocking arrangement with a locking device according to the invention according to FIGS. 3 to 7;

FIGS. 10 and 11 show in an enlarged manner further release positions of the exemplary embodiment of the locking device or pull-out blocking arrangement shown in FIG. 8; and

FIGS. 12 and 13 show another pull-put blocking arrangement with a locking device according to the invention.

### DETAILED DESCRIPTION OF THE PREFERRED EMBODIMENTS

FIGS. 1 and 2 show a generic locking device 1′, as is known from EP 2 497 883 A2.

In the case of said generic locking device 1′, it is provided that a locking body 4′ is mounted in the supporting body 7′ so as to be pivotable about its pivot axis 3′. By way of the fastening devices 21′, in this case in the form of screw holes, the locking device 1′ is able to be fastened on a corresponding pull-out blocking arrangement 2 or on the guide rail 32 thereof

FIG. 1 shows the locking body 4′ of the generic locking device 1′ according to the prior art in the blocking position. FIG. 2 shows the release position. Pivoting the locking body 4′ from the blocking position according to FIG. 1 into the release position according to FIG. 2 is possible exclusively in the pivot direction 5′, that is clockwise. For the closing operation, that is pivoting from the release position according to FIG. 2 into the blocking position according to FIG. 1, the pivot direction 6′ in the case of said prior art has to be realized anticlockwise. This means that in the case of generic locking devices 1′ the opening and closing directions are fixedly predefined, which results in such locking devices 1′ according to the prior art only being able to be used together with locks or closing devices which comprise the same opening and closing direction.

In order then to create a flexible locking device 1 which can be combined with different types of locks or locking devices, the invention provides that the locking body 4 is pivotable about the pivot axis 3 out of the blocking position into at least one of the release positions in two pivot directions 5 and 6 which are opposite one another, as is now explained by way of an exemplary embodiment initially by way of FIGS. 3 to 6. FIGS. 3, 5 and 6 show perspective views of the locking device 1 according to the invention, the locking body 4 being situated in different release positions. FIG. 4 shows a side view with respect to FIG. 3. The blocking position of said locking device 1 or of its locking body 4 can be seen well in FIG. 9.

In the case of the locking device 1 according to the invention, as is shown here in the Figures, the locking body 4 is mounted in the supporting body 7 so as to be pivotable about the pivot axis 3. The supporting body 7 also comprises fastening devices 21 in the form of holes, through which it can be fastened on a pull-out blocking arrangement 2 or on its guide rail 32 by means of screws.

It is provided then according to the invention that the locking body 4 is pivotable about the pivot axis 3 out of the blocking position shown in FIG. 9 both in pivot direction 5, that is clockwise, and also in pivot direction 6 opposite to this, that is anticlockwise, out of the blocking position into at least one release position. In said exemplary embodiment, it is also realized that the locking body 4 when pivoting in pivot directions 5 and 6 does not impact against anything either in the one or in the other direction such that it is able to be pivoted about more than 360°, quasi endlessly, about the pivot axis 3. In the exemplary embodiment shown, the locking body 4 comprises two locking arms 13 and 14 which are spaced apart from one another in the longitudinal direction 9 along the pivot axis 3. These locking arms extend out from the rest of the locking body 4 in the radial direction 12 with reference to the pivot axis 3. By way of their abutment faces 17 and 18, the locking bodies 4, in the blocking position according to FIG. 9, abut against corresponding counter abutment faces 19 and 29 of the stop piece 33 and thus prevent said stop piece 33 being able to be moved upward or in the direction toward the locking device 1.

It is easy to see in FIG. 4 that the abutment faces 17 and 18 in the case of said exemplary embodiment are arranged inclined with respect to the radial direction 12. This is also applicable to the counter abutment faces 19 and 20 in said exemplary embodiment. As a result of this, the locking arms 13 and 14 are prevented from being pressed apart even in the event of strong forces. In the exemplary embodiment shown, the abutment faces 17 and 18 and also the counter abutment faces 19 and 20 comprise an angle of 5° in relation to a plane 36 which stands normally along the radial direction 12, as is shown schematically in FIG. 4.

A space, which corresponds at least to the width of the spring body receiving means 15 of the supporting body 7, is created between the two locking arms 13 and 14, in the exemplary embodiment shown. The achievement here is that when the locking body 4 is pivoted about the pivot axis 3, the locking arms 13 and 14 on opposite sides of the spring body receiving means 15 are pivotable past said spring body receiving means, see, for example, FIGS. 4 and 6.

In order to support the locking body 4 in as sturdy a manner as possible, it is supported or mounted on two bearing points 10 and 11 of the supporting body 7 which are spaced apart from one another in the longitudinal direction 9 of the pivot axis 3. As a result, the locking body 4 can be supported particularly well against forces acting in the radial direction 12. Between the bearing points 10 and 11 which are spaced apart from one another the supporting body 4 is free of a bearing arrangement, that is to say is not mounted. In the exemplary embodiment shown, the locking body 4 comprises two barrel-shaped or roll-shaped portions 37 and 38, by way of which it is mounted on the bearing points 10 and 11 of the supporting body 7.

In the exemplary embodiment shown, latching elements 8 in the form of protruding lugs are provided on the locking body 4 or on the barrel-shaped or roll-shaped portions 37 and 38 thereof. A certain latching-in between the supporting body 7 and the locking body 4 is effected by way of said latching elements 8 when the locking body 4 is situated in a certain position. In the exemplary embodiment shown, these are the release positions according to FIGS. 3 and 4 and the blocking positions according to FIG. 9. Naturally, such latching elements 8 can also be developed in another manner, just as it is possible to provide other defined positions for the latching-in. A plurality of possibilities exists as regards the arrangement and configuration of such latching elements 8. To complete the picture, it must be emphasized that such a latching position can also be departed from again by rotating the locking body further in one of the pivot directions 5 or 6.

To couple the locking body 4 with a corresponding lock, that is, for example, a numeric lock or key lock, the locking device 1 according to the invention comprises the connecting piece 24. By means of said connecting piece, a corresponding lock can act on the locking device 1 to pivot the locking body 4 into the pivot direction 5 or 6. FIG. 7 shows an exploded drawing of the locking device 1 according to the invention of the exemplary embodiment shown here. It can easily be seen here that in said exemplary embodiment the connecting piece 24 is realized integrally with the rest of the locking body 4. Between the connecting piece 24 and the locking arms 13 and 14, the locking body 4 of said exemplary embodiment comprises the neck 26, by way of which it is mounted so as to be pivotable about the pivot axis 3 and rotatable in the rotary bearing 25 of the supporting body 7. The collar 27, which serves for axially supporting the locking body 4 in the longitudinal direction 9 of the pivot axis 3 by the collar 27 being guided between the supporting body 7 and the side part 22, is situated on the side of the neck 26 pointing to the connecting piece 24. The side part 22 is fastened on the supporting body 7 by means of the screw 23.

In FIGS. 8 and 9 a pull-out blocking arrangement 2 according to the invention is shown as an example where a locking device 1 according to the invention is used. Apart from the locking device 1 according to the invention, the pull-out blocking arrangement 2 corresponds substantially to the variant of such a pull-out blocking arrangement disclosed in EP 2 497 883 A2 such that to explain the function of the pull-out blocking arrangement, reference can be made in principle to said document, that is to EP 2 497 883 A2.

In FIG. 8 the locking body 4 is situated in that release position in which its locking arms 13 and 14 point vertically upward. FIG. 9 shows, as already said, the blocking position where the locking arms 13 and 14 of the locking body 4 are pivoted downward and by way of their abutment faces 17 and 18 abut against the counter abutment faces 19 and 20 of the stop piece 33 and consequently prevent the stop piece 33 from being able to be pressed upward, that is in the direction toward the locking device 1.

As described in detail in the prior art, the support elements 31 and also the intermediate elements 34 are mounted so as to be displaceable along the guide rail 32 of the pull-out blocking arrangement 2. This is also applicable to the stop piece 33. This displaceability of all of said elements along the guide rail, however, is only provided for as long as the locking body 4 is situated in one of the release positions and not in the blocking position according to FIG. 9 or another blocking position in which the abutment faces 17 and 18 are still engaged with the counter abutment faces 19 and 20.

In the representations of FIGS. 8 and 9, a fixed stop member 41 is situated on the end of the guide rail 32 opposite the locking device 1. This fixed stop member is not displaceable in the longitudinal direction of the guide rail 32. The bottom-most support element 31 or intermediate element 34 abuts against said fixed stop member. In the exemplary embodiment shown according to FIGS. 8 and 9, this is a relatively short pull-out blocking arrangement 2 for only two extractable furniture parts. However, longer pull-out blocking arrangement 2 for more than two extractable furniture parts, in particular drawers, can be realized in the same manner.

In order then to be able to pull a drawer (not shown), which is fastened on the trigger element carrier 28, or another furniture part which can be pulled out of a furniture body (not shown here either) in the pull-out direction 29 out of the pull-out blocking device 2, the locking body 4 has to be situated in one of the release positions. The support element 31, which was locking said trigger element carrier 28 up to now, can then be pivoted about its pivot axis 3 so far that a journal 39, which is actually not visible here and is only shown in FIG. 8 by the dotted line, is able to be pulled out of the hook-shaped receiving means 40 of the support element 31. In FIG. 8 this is the topmost support element 31 in this case. So that said support element is able to carry out the pivot movement, it has to be displaced upward along the guide rail 32 in the direction toward the locking device 1. However, this also means that the stop piece 33 supported thereon has to be displaced at the same time in the direction toward the locking device 1. This is only possible when the locking body 4 is situated in one of the release positions. If it is situated in the blocking position according to FIG. 9, the stop piece 33 cannot be displaced in the direction of the locking device 1, which results in none of the support elements 31 being able to be pivoted such that the trigger element 28 held therein is able to be pulled out in the pull-out direction 29. The blocking position shown in FIG. 9 therefore ensures that not one single movable furniture part is able to be pulled out of the furniture body. In the situation according to FIG. 8, the pull-out blocking arrangement 2 shown here is realized such that only one single trigger element 28 and consequently one single movable furniture part is able to be pulled out of the furniture body. If this is already the case, as shown in FIG. 8, all the other support elements 31 are also blocked in such a manner that it is no longer possible for any further trigger element 28 and consequently also any further furniture part to be pulled out.

The pushing-in again of the movable furniture parts and consequently of the trigger elements 28 is effected in the push-in direction 30. As soon as the journal 39 is then pushed correspondingly into the hook-shaped receiving means 40, the support element 31 pivots back such that either another trigger element 28 or another movable furniture part is able to be pulled out in the pull-out direction 29 or by pivoting the locking body 4 into the blocking position according to FIG. 9 the entire pull-out blocking arrangement 2 is locked.

The spring body 16 which is clearly visible in FIG. 9, here in the form of a helical spring, is mounted in the spring body receiving means 15 and ensures the stop piece 33 is spring-loaded in the direction toward the support elements 31 or the intermediate elements 34 and consequently ensures a backlash-free position in order to prevent the pull-out blocking arrangement rattling in the release position of the closing device 1.

FIGS. 10 and 11 show further release positions of the locking device 1 according to the invention. In FIG. 10 the locking arms 13 and 14 point rearward and in FIG. 11 they point forward. In all the release positions shown, the stop piece 33 can be displaced toward the locking device 1 by compressing the spring body 16.

In principle, locking devices 1 according to the invention can be used in a plurality of different pull-out blocking arrangement 2. FIGS. 12 and 13 show as an example of this another pull-out blocking arrangement 2, as is also known in the prior art, where the same locking device 1 according to the invention is used in order to block all the furniture parts (not shown here) in their pushed-in position in the blocking position of the locking body 4. FIGS. 12 and 13 show a release position of the locking body 4 in which the stop piece 33 is able to be pushed a little further upward in the direction toward the locking device 1.

In contrast to the pull-out blocking arrangement 2 according to FIGS. 8 and 9, the support elements in the variant according to FIGS. 12 to 13 are not realized integrally but in the form of two support elements 31′ which rest one on top of the other, a pivotable hook 35 being arranged on the respective upper support element 31′. The journals 39 (not shown here) of the trigger element carrier 28 (not shown here either), when being pulled out in the pull-out direction 29, have to be pulled through between in each case two support elements 31 which interact together and follow directly one after another, the hook 35 then being pivoted and thus, by abutting against the lower support element 31, pushing the support elements 31′ lying above and intermediate elements 34 upward. The position where a trigger element carrier 28 and consequently a displaceable or extractable furniture part is pulled out of the furniture body is shown in FIG. 13. The point at which the trigger element carrier 28 (not shown) has been pulled out in the pull-out direction 29 is marked with the arrow 42. In said position, the support elements 31′ and the intermediate elements 34 are clamped between the lower stop member 41 and the locking device 1 such that no further hook 35 is able to be pivoted, as a result of which no further furniture part is able to be pulled out of the furniture body. This is insofar all known per se and does not have to be explained further here.

In any case, it must be stressed that when, in the position according to FIG. 12, the lock 4 with its locking arms 13 or 14 is pivoted downward into the blocking position (not shown here), even in the case of said exemplary embodiment the stop piece 33 is supported such that it is no longer able to be displaced upward in the direction toward the locking device 1. As a result, the support elements 31′ and intermediate elements 34 are also clamped between the locking body 4 and the lower stop member 41 such that all the furniture parts are blocked and are not able to be pulled out in the pull-out direction 29.

### KEY TO THE REFERENCE NUMERALS

1, 1′ Locking device
2 Pull-out blocking arrangement
3, 3′ Pivot axis
4, 4′ Locking body
5, 5′ Pivot direction
6, 6′ Pivot direction
7, 7′ Supporting body
8 Latching element
9 Longitudinal direction
10 Bearing point
11 Bearing point
12 Radial direction
13 Locking arm
14 Locking arm
15 Spring body receiving means
16 Spring body
17 Abutment face
18 Abutment face
19 Counter abutment face
20 Counter abutment face
21, 21′ Fastening device
22 Side part
23 Screw
24 Connecting piece
25 Rotary bearing
26 Neck
27 Collar
28 Trigger element carrier
29 Pull-out direction
30 Push-in direction
31, 31′ Support element
32 Guide rail
33 Stop piece
34 Intermediate element
35 Hook
36 Plane
37 Portion
38 Portion
39 Journal
40 Hook-shaped receiving means
41 Stop member
42 Arrow

1. A locking device for a pull-out blocking arrangement for at least two furniture parts which can be pushed into a furniture body and pulled out of a furniture body, the locking device comprises a locking body which is pivotable about a pivot axis and is pivotable between at least one blocking position for blocking the furniture parts in the pushed-in position and at least one release position for pulling at least one of the furniture parts out of the furniture body, wherein the locking body is pivotable about the pivot axis out of the blocking position into the release position in two pivot directions which are opposite one another.

2. The locking device as claimed in claim 1, wherein the locking body is pivotable about the pivot axis out of the blocking position both clockwise and also counter-clockwise.

3. The locking device as claimed in claim 1, wherein the locking body is pivotable about the pivot axis about more than 360° in at least one of the pivot directions.

4. The locking device as claimed in claim 1, wherein the locking body is mounted in a supporting body so as to be pivotable about the pivot axis and at least one of the locking body or the supporting body comprises at least one latching element for releasably latching the locking body on the supporting body in at least one of the at least one blocking position or the at least one release position.

5. The locking device as claimed in claim 4, wherein the locking body is mounted so as to be pivotable about the pivot axis in the supporting body on at least two bearing points which are spaced apart from one another in a longitudinal direction of the pivot axis.

6. The locking device as claimed in claim 5, wherein the locking body is free of a supporting arrangement between the bearing points which are spaced apart from one another.

7. The locking device as claimed claim 4, wherein the locking body comprises at least one that extends out from the pivot axis in a radial direction.

8. The locking device as claimed in claim 11, wherein the supporting body comprises a spring body receiver for at least one of receiving or supporting a spring body and, when the locking body is pivoted about the pivot axis, the locking arms on opposite sides of the spring body receiver are pivoted past said spring body receiver.

9. The locking device as claimed in claim 1, wherein the locking body comprises at least one abutment face which is arranged inclined with respect to a radial direction, with reference to the pivot axis, for abutting against a counter abutment face of the pull-out blocking arrangement.

10. A pull-out blocking arrangement for at least two furniture parts which can be pushed into a furniture body and pulled out of the furniture body, said pull-out blocking arrangement comprises at least one locking device as claimed in claim 1 for blocking the furniture parts in the pushed-in position.

11. The locking device as claimed in claim 1, wherein the locking body comprises at least two locking arms which are spaced apart from one another in the longitudinal direction of the pivot axis and extend out from the pivot axis in a radial direction.

12. The locking device as claimed in claim 11, wherein the locking arms comprise abutment faces which are arranged inclined with respect to a radial direction, with reference to the pivot axis, for abutting against a counter abutment face of the pull-out blocking arrangement.
